(19) United States
(12) Patent Application Publication
(10) Pub. No.: US 2025/0188977 A1
(43) Pub. Date: Jun. 12, 2025

(54) VERSATILE SCREW

(71) Applicant: ESSENCE METHOD REFINE CO., LTD., TAINAN CITY (TW)

(72) Inventor: LING-FANG CHEN, TAINAN CITY (TW)

(21) Appl. No.: 18/531,126

(22) Filed: Dec. 6, 2023

(51) Int. Cl. F16B 25/10

(52) U.S. Cl. CPC F16B 25/103

(57) ABSTRACT

A versatile screw includes a head, a shank, a thread unit, and a drill portion. The drill portion includes a drill body on which two opposite groove regions and a drill thread unit can be arranged. The drill body defines a drilling section. Each groove region includes at least one wall joined to the drilling section, an accommodation area enclosed by the wall, and a cutting rib portion protruding from the wall. The drill thread unit is spirally disposed on the drilling section and partially cut by the groove regions, thereby forming at least two drilling thread segments. The cutting rib portions cooperate with the drilling thread segments to assist the drilling section in reaming and generating downward pulling force, thereby executing an efficient drilling operation capable of attaining a stable initial-cutting effect, decreasing the drilling resistance and preventing the cracking problem of a workpiece.

### BACKGROUND OF THE INVENTION

### 1. Field of the Invention

This invention relates to a screw and relates particularly to a versatile screw.

### 2. Description of the Related Art

Referring to FIG. 1, a conventional screw 1 includes a shank 11, a head 12 connected to the shank 11, and right-hand threads 13 spiraling around the shank 11. The shank 11 tapers to form a tip 14 opposite to the head 12 and has a groove 15 formed thereon. In operation, the head 12 is rotated to drill the threads 13 into a workpiece (not shown). The groove 15 serves to cut the workpiece and accommodate chips caused by cutting the workpiece, thereby completing a screwing operation. However, the shank 11 only has one groove 15, so the cutting effect is limited, and fibers of the workpiece are not efficiently severed. The groove 15 also fails to help quick removal of the chips and has a limited area for receiving residual chips. Thus, the accumulation of the chips blocks the groove 15 easily and causes larger resistance against the screwing operation. The excessive accumulation of the chips also adds undue pressure to the workpiece, which causes the workpiece to crack easily. Furthermore, the screw 1 only uses the tip 14 to touch the workpiece, so the area of bearing force is small. In this regard, the tip 14 deviates from its right position easily while being subjected to improper force, and the deviation affects the screwing operation of the screw 1. Thus, the screw 1 still needs to be improved.

### SUMMARY OF THE INVENTION

An object of this invention is to provide a versatile screw capable of reaming, reducing the drilling resistance for a quick drilling effect, and preventing the workpiece from cracking.

A versatile screw of this invention includes a head, a shank extending outwards from the head, a thread unit disposed on the shank, and a drill portion connected to the shank. The shank defines a central axis. The thread unit includes a plurality of threads spirally disposed around an outer periphery of the shank. The drill portion includes a drill body connected to the shank, two opposite groove regions formed on the drill body, and a drill thread unit winding around the drill body. The drill body extends outwards from the shank and defines a drilling section which includes an end portion formed in opposing relationship to the shank. Each groove region includes at least one wall connected to the drilling section and a cutting rib portion protruding outwards from the wall. An accommodation area is enclosed by the at least one wall for receiving and removing chips. The outward protrusion of each cutting rib portion defines an end point furthest from the central axis. When viewed from the end portion, a first distance is defined from an end point of one cutting rib portion of one groove region to the other end point of the other cutting rib portion of the other groove region, and a second distance is defined from a junction where the wall of the one groove region and the outer periphery of the drilling section meet to the other junction where the other wall of the other groove region and the outer periphery of the drilling section meet. The first distance is greater than the second distance. The drill thread unit is disposed in at least one convolution winding around the outer periphery of the drilling section, and concurrently the drill thread unit is partially cut by the two groove regions so that at least two drilling thread segments protrude outwards from the outer periphery of the drilling section. Each drilling thread segment is situated on one side of each cutting rib portion.

In accordance with the above arrangement, the drill thread unit and the cutting rib portions arranged on the drilling section cooperate to enlarge a drilled hole and generate downward pulling force while drilling, which not only subjects a workpiece to a cutting operation for drilling the drill portion into a workpiece quickly but also prevents the drill portion from deviating from its right position. The cutting operation of the cutting rib portions also helps reduce the drilling resistance which the drilling thread segments suffer. Accordingly, the combination of the correlated elements of the screw subjects the workpiece to quick cutting force and efficient removal of chips, thereby preventing the workpiece from cracking.

Preferably, in one preferred embodiment, the value of the first distance can be 1.01˜1.5 times the value of the second distance, which is conducive to cutting and accommodating chips.

Preferably, the outer periphery of the drilling section defines a drill diameter, and the outer periphery of the shank defines an outer diameter. In one preferred embodiment, the value of the drill diameter can be 1.01˜1.4 times the value of the outer diameter. In another preferred embodiment, the value of the outer diameter can be 1.01˜1.4 times the value of the drill diameter.

Preferably, the drilling section can taper directly so that the end portion is formed with a single drill tip for presenting a sharp end configuration. Alternatively, the end portion includes two inclined first cones, and the first cones converge at the drill tip for presenting a drill tip configuration. With respect to both configurations, the drill tip has a third included angle ranging from 40 to 120 degrees.

Preferably, in one preferred embodiment, the end portion can be formed with an end surface instead of the single drill tip. It is possible that a recess is recessed into the end surface. It is also possible that one end edge of the end surface is connected to one of the drilling thread segments.

Preferably, in one preferred embodiment, a plurality of notches can be arranged on at least one thread. In another preferred embodiments showing the aforementioned drill tip configuration, a plurality of first or second indentations can be arranged on the outer periphery of the drilling section or on the first cones. The notches and indentations are conducive to an auxiliary cutting effect.

Preferably, in one preferred embodiment, the drill body can be twisted in a direction to present a helical form.

Each of the groove regions has at least one wall. In one preferred embodiment, each groove region can include a first wall connected to an outer periphery of the drilling section and extending towards the end portion, a second wall joined to the first wall and located between the first wall and the shank, and a third wall joined to both of the first wall and the second wall. Accordingly, the accommodation area can be enclosed by the walls, and the cutting rib portion can be formed on the third wall so that the cutting rib portion protrudes outwards from the third wall.

Preferably, in one preferred embodiment, each wall of each groove region can be flat or be curved in surface. In another preferred embodiment, a joint where the first wall, the second wall, and the third wall are joined can have an arcuate surface. Alternatively, the wall can have a spherical-curved surface. These specific surfaces allow the accommodation area to be in the form of a special contour, such as a spherical or a quasi-spherical contour. Thus, the improper accumulation of chips can be prevented.

Preferably, each thread of the thread unit includes opposite upper and lower thread surfaces. The upper thread surface faces the head. The upper thread surface and the lower thread surface converge at an apex which defines a baseline perpendicular to the central axis. A first included angle is defined between the upper thread surface and the baseline, and a second included angle is defined between the lower thread surface and the baseline. The first included angle can be equal to or different from the second included angle.

Preferably, each drilling thread sections includes opposite upper and lower flank surfaces. The upper flank surface faces the head. The upper flank surface and the lower flank surface converge at a crest which defines a reference line perpendicular to the central axis. A fourth included angle is defined between the upper flank surface and the reference line, and a fifth included angle is between the lower flank surface and the reference line. The fourth included angle can be equal to or different from the fifth included angle.

Preferably, the sum of the first included angle and the second included angle does not exceed the sum of the fourth included angle and the fifth included angle, thereby assisting the screw in reducing the drilling resistance.

Preferably, in one preferred embodiment, the threads and the shank can have a non-circular shape, such as a triangular shape or a quadrilateral shape, to facilitate a sharp cutting operation.

Preferably, in one preferred embodiment, the groove region is formed on the drilling section. The groove region formed on the drilling section can extend towards the head to prolong the extension. In other words, the groove region can be extended in length. It is also possible that the drill thread unit is disposed in more than one convolution, thereby expanding the range of the drilling thread segments.

### BRIEF DESCRIPTION OF THE DRAWINGS

FIG. 1 is a schematic view showing a conventional screw;

FIG. 2 is a schematic view showing a first preferred embodiment of this invention when viewed in one side;

FIG. 2A is a cross-sectional view showing an encircled portion X1 of FIG. 2;

FIG. 2B is a cross-sectional view showing one variation of FIG. 2A;

FIG. 2C is a cross-sectional view showing an encircled portion X2 of FIG. 2;

FIG. 2D is a cross-sectional view showing one variation of FIG. 2C;

FIG. 2E is a cross-sectional view taken along A-A line of FIG. 2;

FIG. 2F is a cross-sectional view showing one variation of FIG. 2E;

FIG. 2G is a cross-sectional view showing another variation of FIG. 2E;

FIG. 3 is a schematic view showing the first preferred embodiment when viewed in another side;

FIG. 3A is a perspective view showing an encircled portion X3 of FIG. 3;

FIG. 3B is a bottom plan view of FIG. 3;

FIG. 4 is a partial schematic view showing one variation of the first preferred embodiment;

FIG. 5 is a schematic view showing another variation of the first preferred embodiment;

FIG. 6 is a schematic view showing a further variation of the first preferred embodiment;

FIG. 6A is a perspective view showing an encircled portion X4 of FIG. 6;

FIG. 6B is a bottom plan view of FIG. 6;

FIG. 7-1 and FIG. 7-2 are schematic views showing other further variations of the first preferred embodiment;

FIG. 8 is a schematic view showing an operation of the first preferred embodiment;

FIG. 9 is a schematic view showing a second preferred embodiment of this invention;

FIG. 9A is a perspective view showing an encircled portion X5 of FIG. 9;

FIG. 9B is a bottom plan view of FIG. 9;

FIG. 10 is a schematic view showing a third preferred embodiment of this invention;

FIG. 11 is a schematic view showing a fourth preferred embodiment of this invention;

FIG. 12 is a schematic view showing a fifth preferred embodiment of this invention when viewed in one side;

FIG. 12A is a perspective view showing an encircled portion X6 of FIG. 12;

FIG. 12B is a bottom plan view of FIG. 12;

FIG. 13 is a schematic view showing a sixth preferred embodiment of this invention;

FIG. 13A is a perspective view showing an encircled portion X7 of FIG. 13;

FIG. 14 is a schematic view showing a seventh preferred embodiment of this invention;

FIG. 14A is a perspective view showing an encircled portion X8 of FIG. 14;

FIG. 15 is a schematic view showing an eighth preferred embodiment of this invention;

FIG. 15A is a perspective view showing an encircled portion X9 of FIG. 15;

FIG. 16 is a schematic view showing a ninth preferred embodiment of this invention;

FIG. 16A is a perspective view showing an encircled portion X10 of FIG. 16;

FIG. 16B is a bottom plan view of FIG. 16;

FIG. 17 is a schematic view showing a tenth preferred embodiment of this invention;

FIG. 17A is a bottom plan view of FIG. 17;

FIG. 18 is a schematic view showing an operation of FIG. 17;

FIG. 19 is a schematic view showing one variation of an eleventh preferred embodiment of this invention;

FIG. 19A is a bottom plan view of FIG. 19;

FIG. 20 is a schematic view showing an operation of FIG. 19;

FIG. 21 is a schematic view showing another variation of the eleventh preferred embodiment;

FIG. 21A is a bottom plan view of FIG. 21; and

FIG. 22 is a schematic view showing an operation of FIG. 21.

### DETAILED DESCRIPTION OF THE PREFERRED EMBODIMENTS

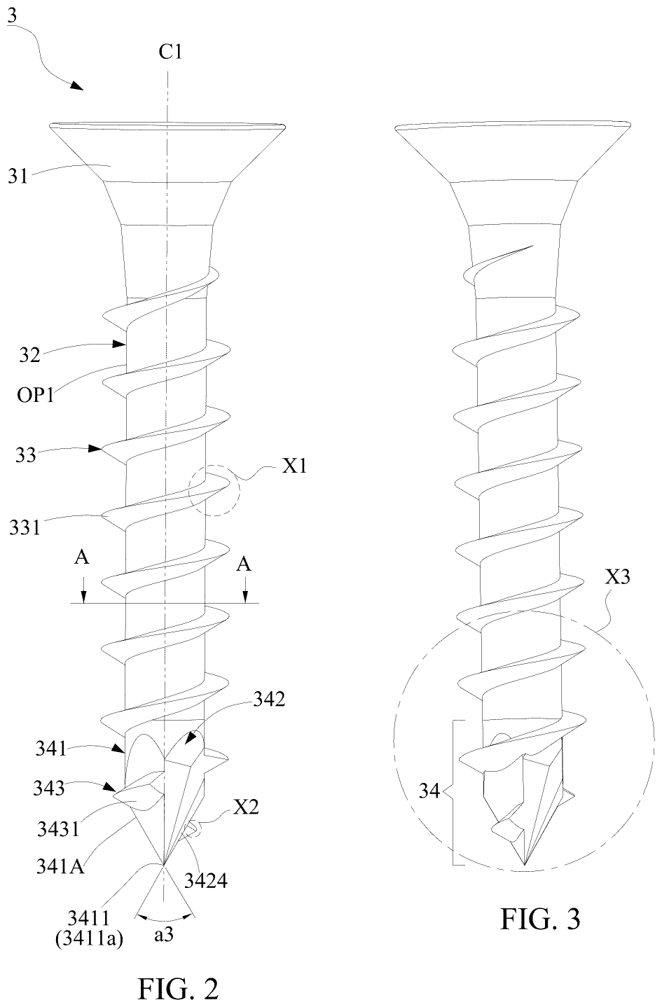

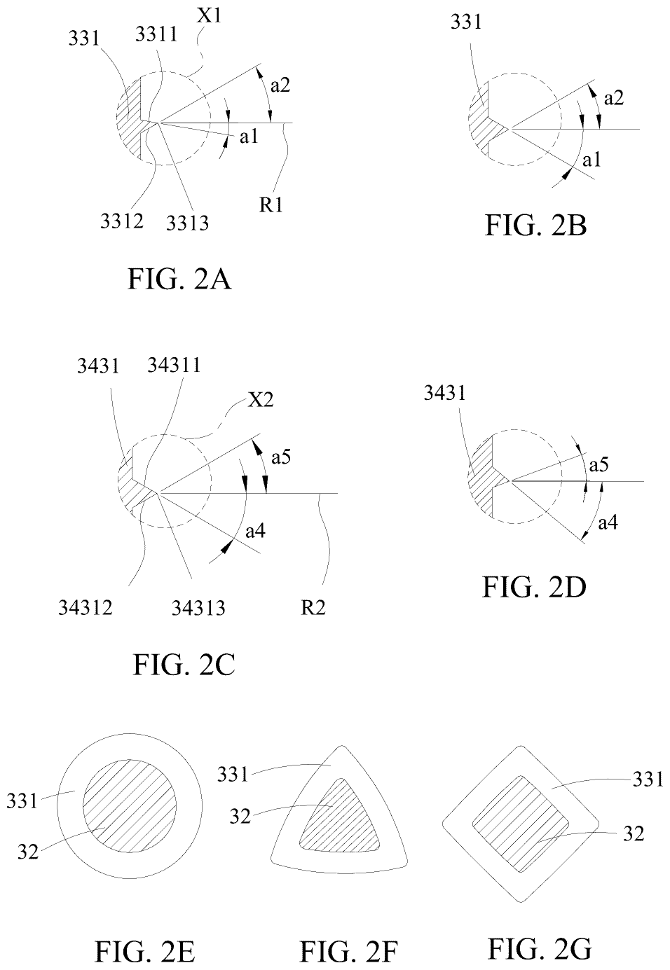

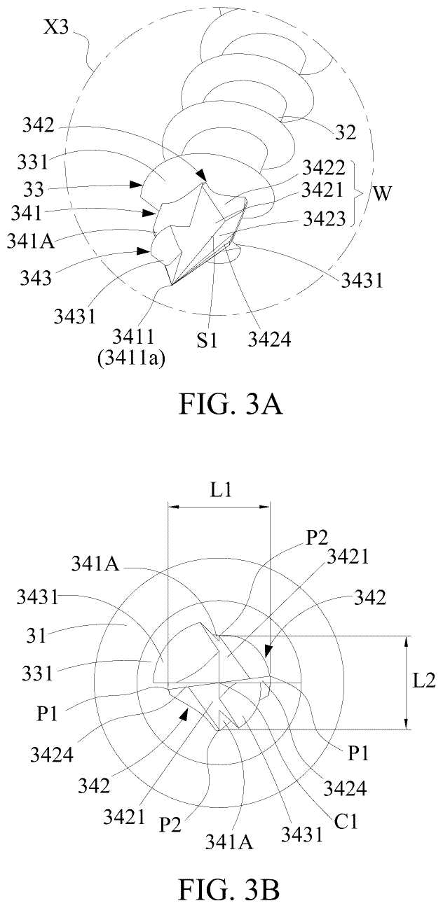

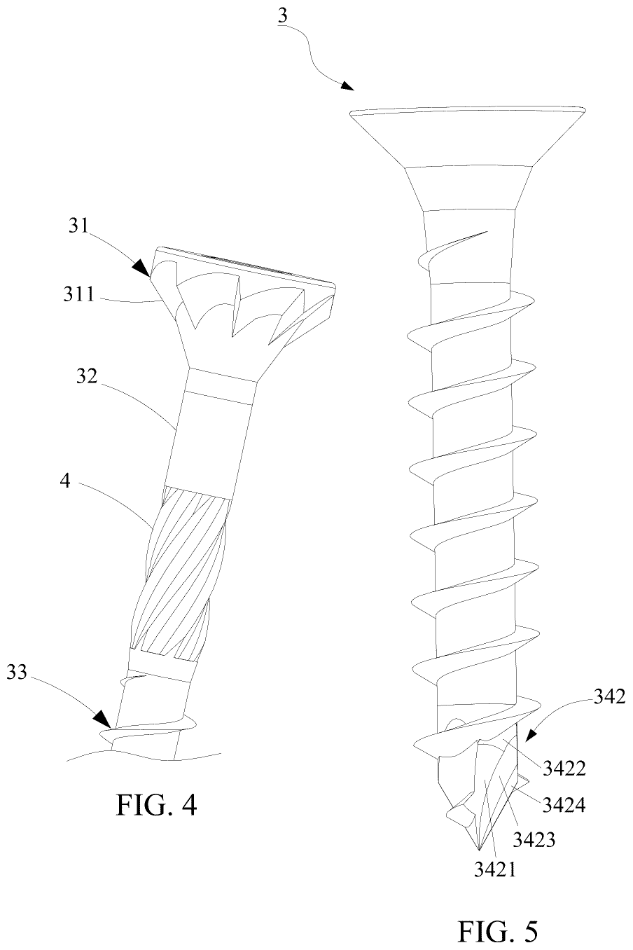

Referring to FIG. 2 and FIG. 3, a first preferred embodiment of the versatile screw 3 is shown. The screw 3 includes a head 31, a shank 32 extending outwards from the head 31, a thread unit 33 spirally disposed on the shank 32, and a drill portion 34 connected to the shank 32. Specifically, the appearance of the head 31 is adjustable to meet demand. For example, multiple ribs 311, shown in FIG. 4, can be formed on a bottom surface of the head 31 for attaining an auxiliary cutting effect and an anti-loosening effect. Furthermore, the shank 32 extends axially from the head 31 and defines a central axis C1. An auxiliary thread 4, shown in FIG. 4, can be disposed on the shank 32 and located between the thread unit 33 and the head 31. A helical angle of the auxiliary thread 4 is different from a spiral angle of the thread unit 33 so that the auxiliary thread 4 follows the thread unit 33 to continue the drilling operation.

Referring to FIG. 2A, the thread unit 33 includes a plurality of threads 331 spirally disposed around an outer periphery OPT of the shank 32. Each thread 331 includes an upper thread surface 3311 facing the head 31 and a lower thread surface 3312 opposite to the upper thread surface 3311. The upper thread surface 3311 and the lower thread surface 3312 converge at an apex 3313. The apex 3313 defines a baseline R1 perpendicular to the central axis C1. As shown in FIG. 2A, a first included angle a1 defined between the baseline R1 and the upper thread surface 3311 can be different from a second included angle a2 defined between the baseline R1 and the lower thread surface 3312. Alternatively, the angle a1 can be equal to the angle a2, as shown in FIG. 2B. The operation of the screw will be described by taking the different angles a1, a2 as an example, thereby drilling the threads 331 into a workpiece quickly with smaller drilling resistance and attaining pull-out resistance whereby the screw 3 is not easily pulled out of the workpiece. Furthermore, the shank 32 and the threads 331 can be circular in shape or be in the form of a non-circular shape, such as triangular (shown in FIG. 2F) and quadrilateral (shown in FIG. 2G). Especially, the non-circular shape helps a sharper cutting operation, thereby driving the screw without much effort. The operation of the screw will be described by taking the circular shape shown in FIG. 2E as an example

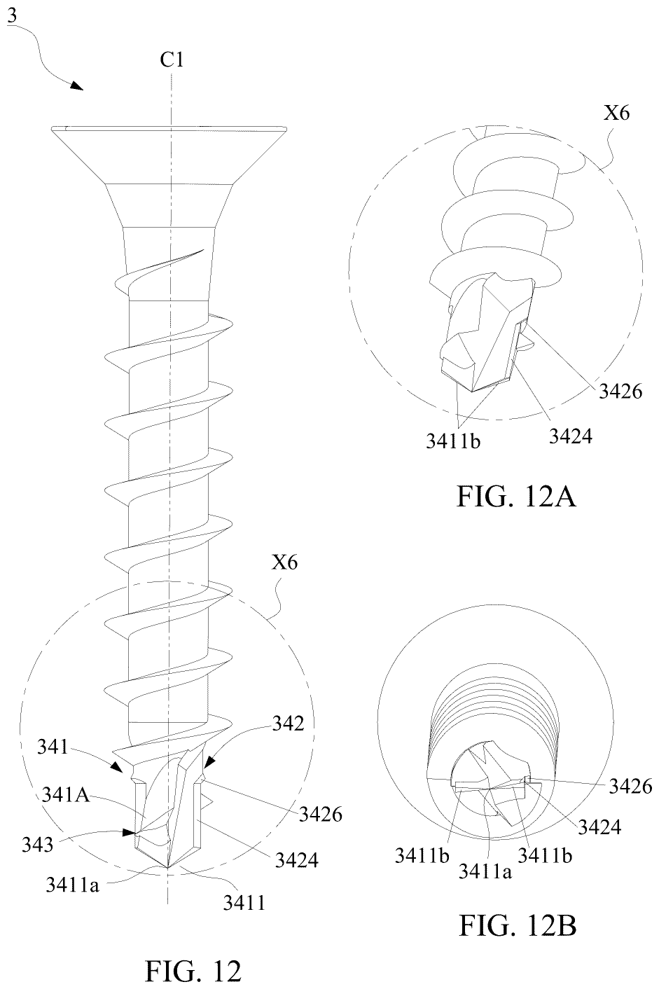

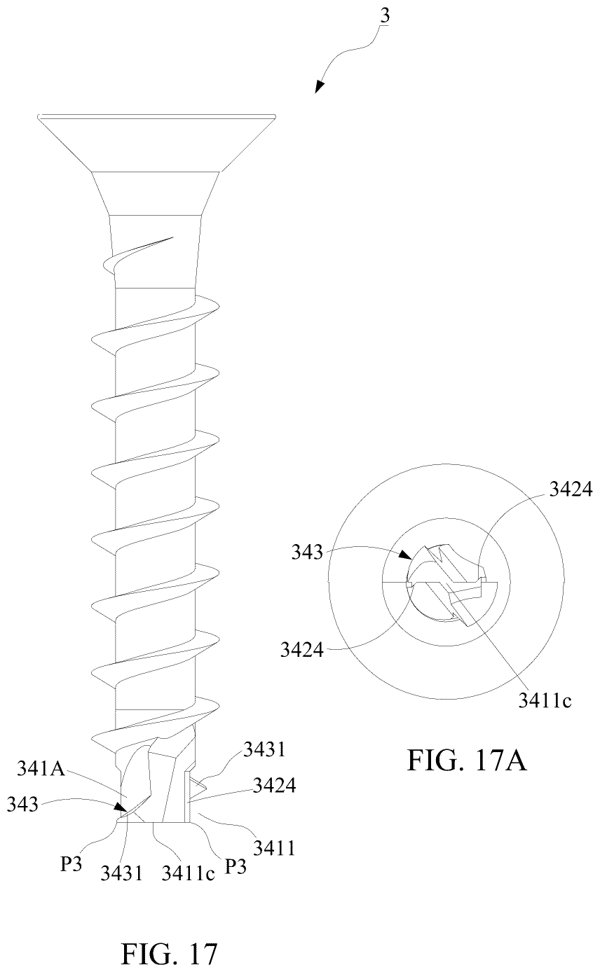

Referring to FIG. 3 and FIG. 3A, the drill portion 34 includes a drill body 341, two groove regions 342, and a drill thread unit 343. The drill body 341 is connected to the shank 32. Specifically, the drill body 341 extends outwards from the shank 32, and the extension also defines a drilling section 341A. The drilling section 341A is a section whose conical surface is shaped by cutting and on which any cavity, i.e. groove regions, can be formed. Therefore, the drilling section 341A is a section capable of cutting fibers of the workpiece, accommodating chips, and removing chips. The drilling section 341A includes an end portion 3411 located in opposing relationship to the shank 32. It is possible that the drilling section 341A inclines towards the central axis C1 and tapers to form the end portion 3411, so the end portion 3411 itself, shown in FIG. 2, becomes a single drill tip 3411a because of the tapering structure. It is also possible that the end portion 3411 is formed by a drill structure with the single drill tip 3411a, which will be shown and described according to FIG. 12. Regarding both structures shown in FIG. 2 and FIG. 12, the central axis C1 can pass the drill tip 3411a so that the drill tip 3411a serves as a central drill end. The drill tip 3411a further defines a third included angle a3 ranging from 40 to 120 degrees, preferably from 60 to 90 degrees. Alternatively, the end portion 3411 can be made without the drill tip 3411a, which will be shown and described from FIG. 17 to FIG. 22. Therefore, the appearance of the end portion 3411 is adjustable according to workpieces made of different materials.

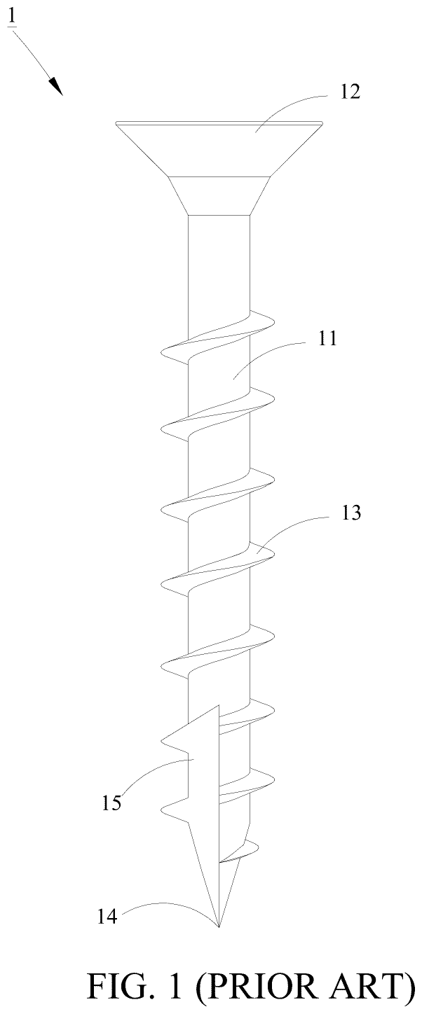

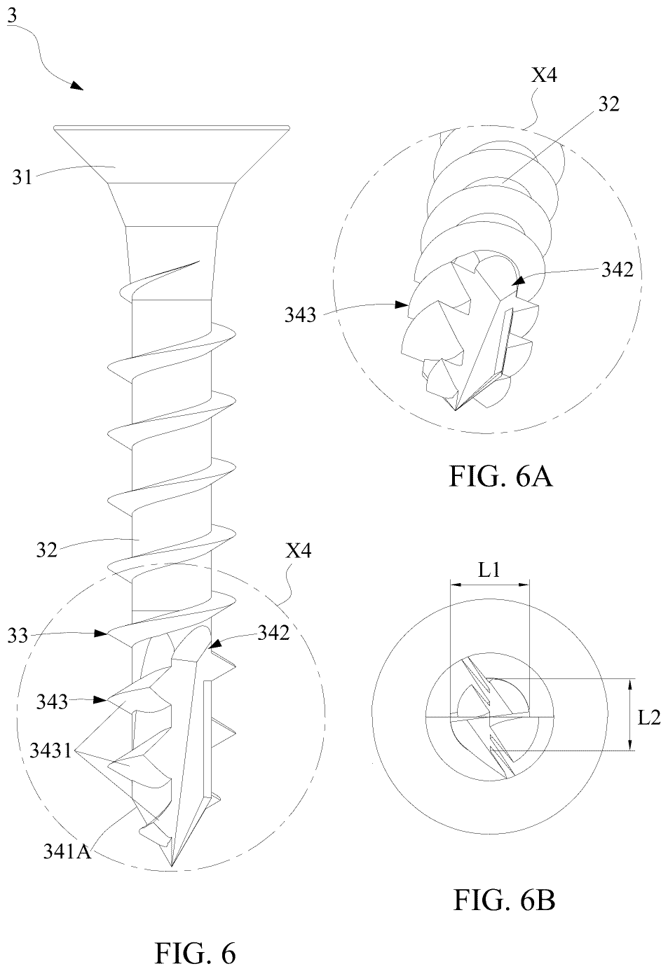

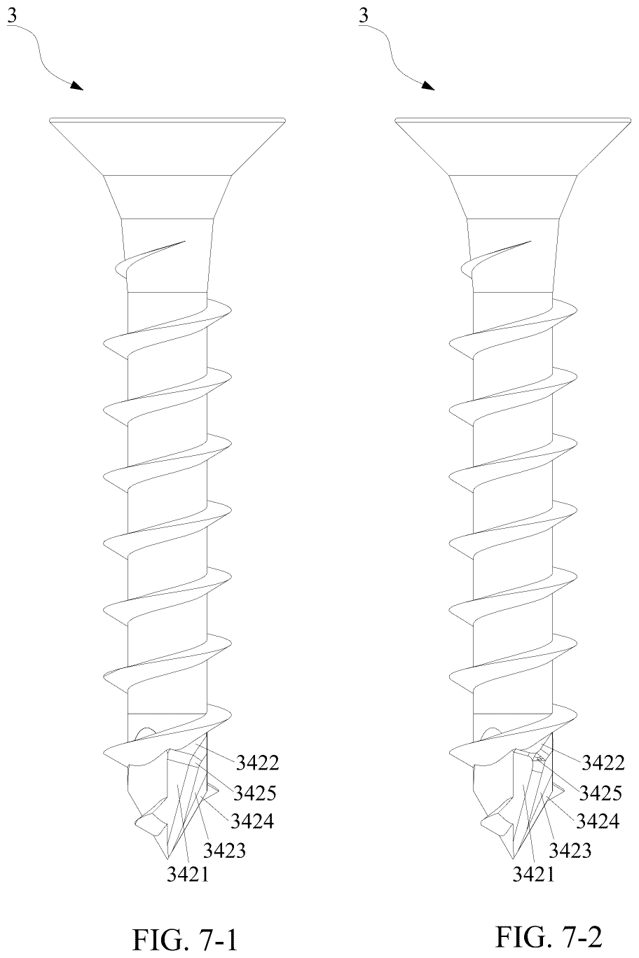

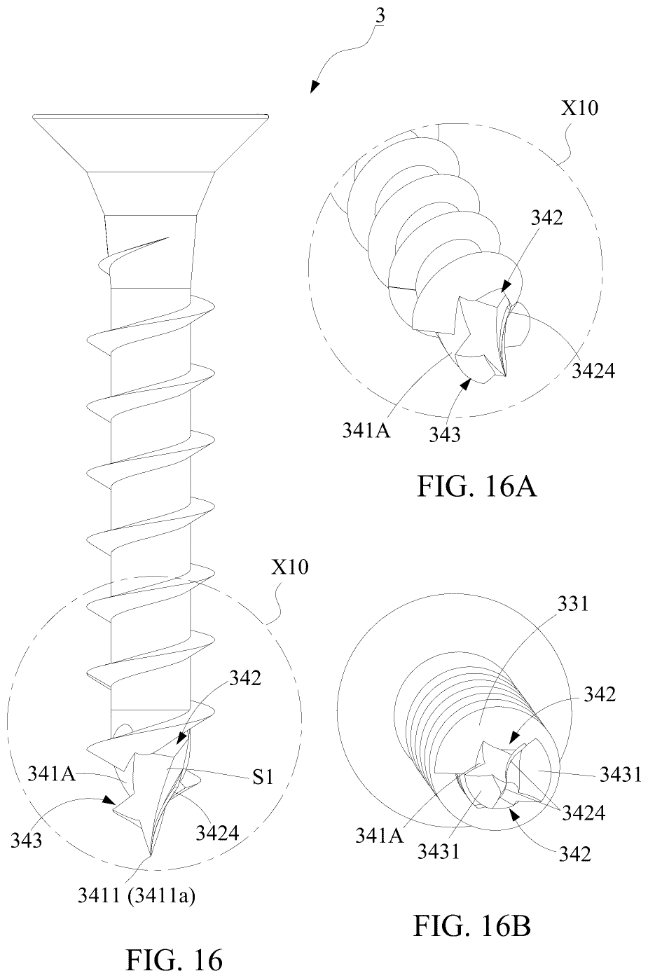

Referring to FIG. 2, two opposite groove regions 342 are formed on the drill body 341. Specifically, on the drill body 341 is formed a groove portion which includes two opposite groove regions 342 recessed into the drilling section 341A. Furthermore, as shown in FIG. 6, each groove region 342 formed on the drilling section 341A can also be extended towards the head 31, thereby enlarging the length of each groove region 342. Each groove region 342 defines an accommodation area S1 enclosed by at least one wall W. It is possible that the accommodation area S1 is enclosed by one or more than one wall. In the preferred embodiments of this invention, three walls W are taken as an example. In this case, the groove region 342 includes a first wall 3421 connected to an outer periphery of the drilling section 341A and extended in the direction of the end portion 3411, a second wall 3422 joined to the first wall 3421 and located between the first wall 3421 and the shank 32, and a third wall 3423 joined to the first wall 3421 and the second wall 3422. Accordingly, the first wall 3421, the second wall 3422, and the third wall 3423 surround the accommodation area S1, which not only accommodates chips but also guides chips out of the workpiece to prevent the undue accumulation of chips. Moreover, each surface of the first wall 3421, the second wall 3422, and the third wall 3423 can be, but not limited to, a flat surface (FIG. 2), a curved surface (FIG. 5), a helical arrangement (FIG. 16), etc. If the surfaces are flat or curved, the accommodation area S1 attains the accommodation and removal of chips and possesses the sharpness conducive to cutting. The operation of this invention will be described with the aid of FIG. 2. when the groove region 342 only has one wall with a spherical-curved surface or when a joint where the walls 3421, 3422, 3423 are joined has an arcuate surface 3425 (shown in FIG. 7-1 and FIG. 7-2) by which a spherical contour is constructed, the accommodation area S1 as a whole serves as an area having a spherical or a quasi-spherical shape so that the chips are not easily accumulated.

Referring to the bottom plan view of FIG. 3B when viewed from the end portion 3411, the first wall 3421 of one groove region 342 and the outer periphery of the drilling section 341A converge at a junction P2. The junction P2 can be the point of the first wall 3421 furthest from the central axis C1. The other first wall 3421 of the other groove region 342 and the outer periphery of the drilling section 341A converge at the other junction P2. A length between the two junctions P2 is defined as a second distance L2.

Each groove region 342 further includes a cutting rib portion 3424 which protrudes outwards from at least one wall W. As for example shown in the figures, the cutting rib portion 3424 is located on the third wall 3423 and formed by protruding outwards therefrom. According to FIG. 3B, the outward protrusion allows the cutting rib portion 3424 to define an end point P1 which is furthest from the central axis C1. With regard to the two opposite groove regions 342, one cutting rib portion 3424 of one groove region 342 defines one end point P1, and the other cutting rib 3424 of the other groove region 342 defines the other end point P1. A length between the two end points P1 is defined as a first distance L1. The first distance L1 is greater than the second distance L2. The value of the first distance can be 1.01˜1.5 times the value of the second distance, and preferably 1.01˜1.2 times.

The drill thread unit 343 is spirally disposed on the drill body 341. Particularly, the drill thread unit 343 is disposed in at least one convolution winding around the outer periphery of the drilling section 341A, and one convolution is shown in FIG. 2. Alternatively, FIG. 6 shows more than one convolution to enlarge the distribution of the drilling thread segments 3431. For example, the number of the drilling thread segments 3431 can be increased because of the multiple convolutions. Therefore, the cooperation between the drilling section 341A and the drill thread unit 343 enlarges a drilled hole and generates downward pulling force for drilling the drill portion 34 into the workpiece. Under the drill thread unit 343 which is disposed in one or more than convolution, a partial portion of the drill thread unit 343 is cut by the groove regions 342. In this case, the uncut portion thereof, defined as two drilling thread segments 3431 (FIG. 2) or more than two drilling thread segments 3431 (FIG. 6), can protrude outwards from the outer periphery of the drilling section 341A. Each drilling thread segment 3431 is situated on one side of each cutting rib portion 3424. Furthermore, each drilling thread segment 3431 includes an upper flank surface 34311 facing the head 31 and a lower flank surface 34312 opposite to the upper flank surface 34311. The upper flank surface 34311 and the lower flank surface 34312 converge at a crest 34313. The crest 34313 defines a reference line R2 perpendicular to the central axis C1. Referring to FIG. 2C, a fourth included angle a4 defined between the upper flank surface 34311 and the reference line R2 can be equal to a fifth included angle a5 defined between the lower flank surface 34312 and the reference line R2. The included angles a4, a5 can be set by 30 degrees or other proper degrees to cause different downward pulling speeds, which assist the drill portion 34 in drilling into the workpiece. Alternatively, the included angles a4, a5 can be different from each other, as for example shown in FIG. 2D where the angle a4 is greater than the angle a5. The operation of the screw will be described by taking FIG. 2C where the angle a4 is equal to the angle a5 as an example.

The scenario is that the sum of the two included angles a1, a2 of the thread 331 is not greater than the sum of the two included angles a4, a5 of the drilling thread segment 3431. That is, the sum of the included angles a4, a5 is greater than or equal to the sum of the included angles a1, a2. Accordingly, the drilling thread segments 3431 attains an initial drilling effect at the beginning of the drilling operation, thereby reducing the drilling resistance which impinges on the drilling process of the threads 331. Regarding the operation of the first preferred embodiment, it is shown that the sum of the included angles a4, a5 (e.g. 60 degrees) is larger than the sum of the included angles a1, a2 (e.g. 40 degrees).

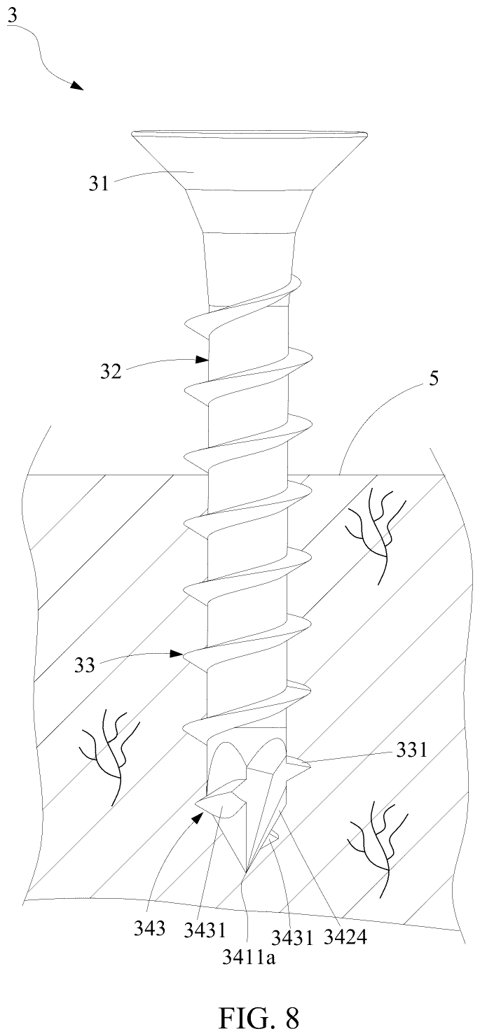

The operation of this invention is described with the aid of FIG. 2, FIG. 3, and FIG. 8. The screw 3 is adapted to be drilled into a workpiece 5 made of iron, wood (hard wood and soft wood), cement, etc. so that the screw 3 is adapted to different kinds of workpieces for multipurpose applications. Herein, the workpiece 5 made of wood is taken as an example. In use, the end portion 3411, i.e. drill tip 3411a, is put against a surface of the wood 5, and then the head 31 is rotated to execute a drilling operation. At the beginning of the drilling operation, fibers inside the wood 5 are cut by each groove region 342. Explicitly, each cutting rib portion 3424 cooperates with each accommodation area S1 enclosed by the walls 3421, 3422, 3423 to carry out a cutting action whereby the fibers crossing each other are severed by cutting. This cutting action reduces the friction between the wood 5 and the drill portion 34. During the process of cutting the fibers with the cutting rib portions 3424 and forming a drilled hole, the cutting rib portions 3424 assist the drilling section 341A in enlarging the drilled hole for attaining a reaming effect, and the drilling thread segments 3431 beside the cutting rib portions 3424 also generate downward pulling force. Therefore, the cutting rib portions 3424 cut the wood 5 and drive the drill body 341 into wood 5 quickly. Meanwhile, the drill tip 3411a does not deviate from its right position against the wood easily. Therefore, the drill thread unit 343 can be stably engaged with the wood 5 at the beginning of the drilling operation.

During the drilling operation of the drill portion 34, chips are generated while cutting the fibers with the cutting rib portions 3424. Because the first distance L1 is larger than the second distance L2, a spiral track is formed while drilling the cutting rib portions 3424 into the wood 5 by cutting. This action not only enlarges the drilled hole for attaining the reaming effect but also cooperates with the accommodation areas S1 for accommodating and removing the chips. Therefore, the undue accumulation and the outward pushing force of the chips can be efficiently prevented so that the wood 5 does not crack easily. Then, the drilling thread segments 3431 enter the wood 5 directly by following the spiral track, so the drilling thread segments 3431 are engaged with the wood 5 and drilled into the wood 5 by cutting. Consequently, the spiral track helps decrease the resisting force that the drill thread unit 343 suffers, thereby reducing the drilling resistance and attaining a quick drilling effect. Thereafter, the chips move along the spiral direction of the drill thread unit 343 and the accommodation areas S1 and then enter the shank 32. The chips are thence removed from the head 31 by following a spiral direction of the thread unit 33. Therefore, the screw 3 attains a quick removal of chips, increases the drilling efficiency, prevents the cracking problem of the wood, and attains a stable screwing effect by accommodating enough chips.

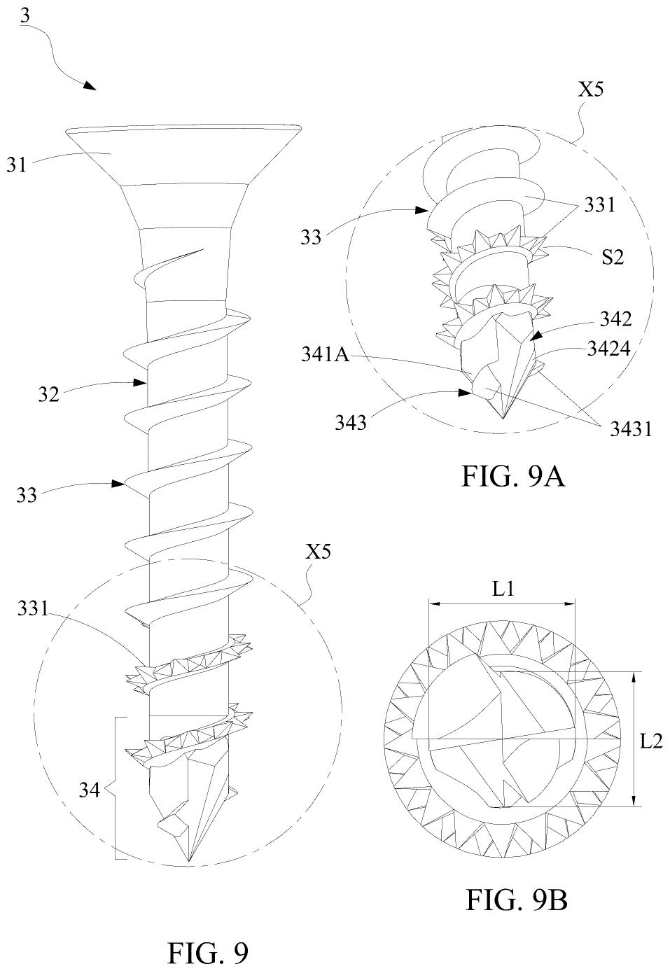

Referring to FIG. 9, a second preferred embodiment of the versatile screw 3 is shown. Elements, the concatenation of correlated elements, the operation, and effects of the second preferred embodiment are the same as those of the first preferred embodiment and herein are omitted. In the second preferred embodiment, there can be a plurality of notches S2 arranged on at least one thread 331 of the thread unit 33. It is shown in the figure that multiple threads 331 each have notches S2 formed thereon to present a structure with an alternation of concavity and convexity, such as a serrated structure and a wave-like structure. The notches S2 assist the thread unit 33 in cutting, thereby attaining an auxiliary cutting effect. The combination of the correlated elements also decreases the drilling resistance, removes chips, prevents the workpiece from cracking, and increases the drilling efficiency.

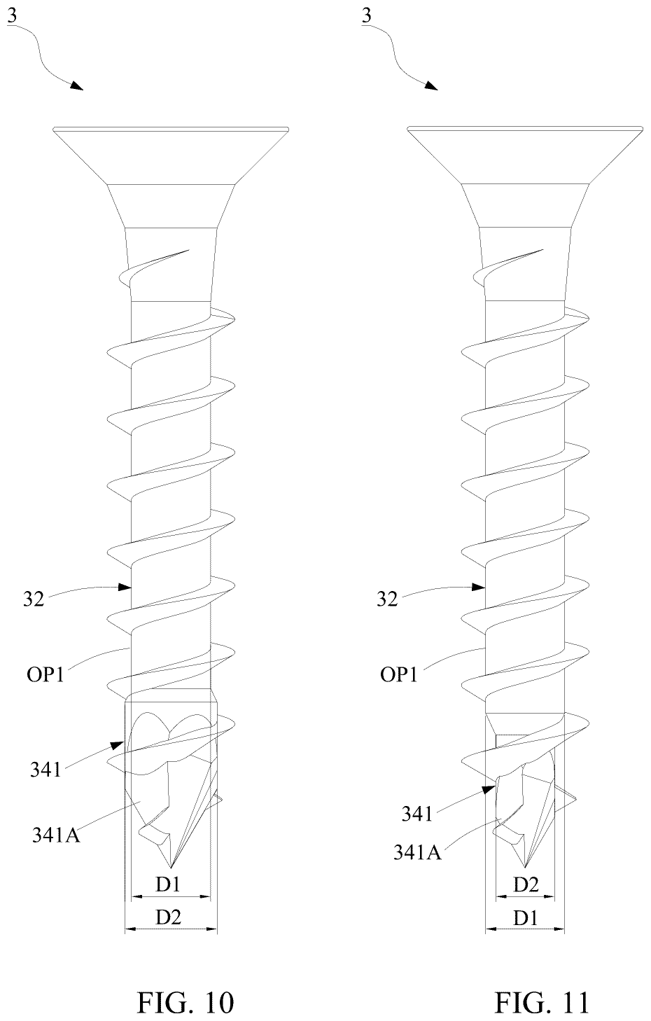

Referring to FIG. 10, a third preferred embodiment of the versatile screw 3 is shown. Elements, the concatenation of correlated elements, the operation, and effects of the second preferred embodiment are the same as those of the first preferred embodiment and herein are omitted. In the third preferred embodiment, the outer periphery of the drilling section 341A defines a drill diameter D2, and preferably the drill diameter D2 may be the largest width of the outer periphery of the drilling section 341A. The outer periphery OP1 of the shank 32 defines an outer diameter D1. The drill diameter D2 is greater than the outer diameter D1, and preferably the value of the drill diameter D2 is 1.01˜1.4 times the value of the outer diameter D1. Accordingly, the screw 3 can be drilled into a workpiece made of hardwood or a brim of a wooden plate. Generally, when the hardwood or the plate brim is squeezed by the drilling action of the screw 3, the hardwood or the plate brim may crack easily in case they are unable to bear the squeezing force. In this preferred embodiment, the wider drilling section 341A reams by making a drilled hole larger and serves to accommodate, guide, and remove the chips. The reaming action further prevents the wood from cracking. Accordingly, the combination of the correlated elements also decreases the drilling resistance, removes chips, prevents the cracking problem of the workpiece, and increases the drilling efficiency.

Referring to FIG. 11, a fourth preferred embodiment of the versatile screw 3 is shown. Different from the third preferred embodiment, the fourth preferred embodiment is characterized in that the drill diameter D2 is smaller than the outer diameter D1, and preferably the value of the outer diameter D1 is 1.01˜1.4 times the value of the drill diameter D2. Accordingly, the screw 3 can be drilled into a workpiece made of softwood, gypsum, plastic, calcium silicate, etc., and herein the workpiece 5 made of softwood with a soft organization is taken as an example. Generally, when the screw 3 is drilled into the softwood, the external vibration, pulling force, or other factors may break the organization of the softwood easily. This situation causes the screw 3 to become loose easily and even escape from the workpiece. In this preferred embodiment, the narrower drilling section 341A serves to form a smaller drilled hole at the time of drilling, and then the wider shank 32 keeps drilling into the drilled hole and pressurizes the interior of the workpiece, which allows the screw 3 to be engaged with the workpiece more firmly for having a closer combination between the screw 3 and the workpiece. Therefore, the fastening force can be enhanced to attain an anti-loose effect whereby the loose screw is prevented. Accordingly, the combination of the correlated elements decreases the drilling resistance, prevents the workpiece from cracking, and increases the drilling efficiency.

Referring to FIG. 12, a fifth preferred embodiment of the versatile screw 3 is shown. Elements of the fifth preferred embodiment are the same as those of the first preferred embodiment. However, the first preferred embodiment is shown in FIG. 2 by defining the end portion 3411 of the drilling section 341A as the drill tip 3411a, thereby presenting a sharp end structure. In the fifth preferred embodiment, FIG. 12A and FIG. 12B show that the end portion 3411 includes two first cones 3411b each inclined to the central axis C1, and the two first cones 3411b are in opposing relationship so that the first cones 3411b meet at the drill tip 3411a to present a drill tip structure.

When the drill tip structure is made, each groove region 342 can further include a second cone 3426 located on the drilling section 341A and spaced from the end portion 3411. The second cone 3426 is inclined to the central axis C1 and extended outwards from the outer periphery of the drilling section 341A. Accordingly, the second cones 3426 are each in a state of inclination and outward extension. By the cooperation between the drill tip structure and the aforementioned features of the drill portion 34, the screw 3 can be drilled into a workpiece, such as an iron board and cement. The first cones 3411b serve to carry out an initial hole-drilling action and make the drilled hole larger for reaming, and then the cutting rib portions 3424 and the second cones 3426 keep cutting the workpiece for reaming again so that the drill portion 34 is quickly drilled into the workpiece. Overall, this preferred embodiment allows the drilled hole to be reamed twice to attain a quicker drilling operation and facilitate the accommodation and the removal of chips. Accordingly, the combination of the correlated elements allows the screw 3 to decrease the drilling resistance, prevent the cracking problem of the workpiece, and increase the drilling efficiency.

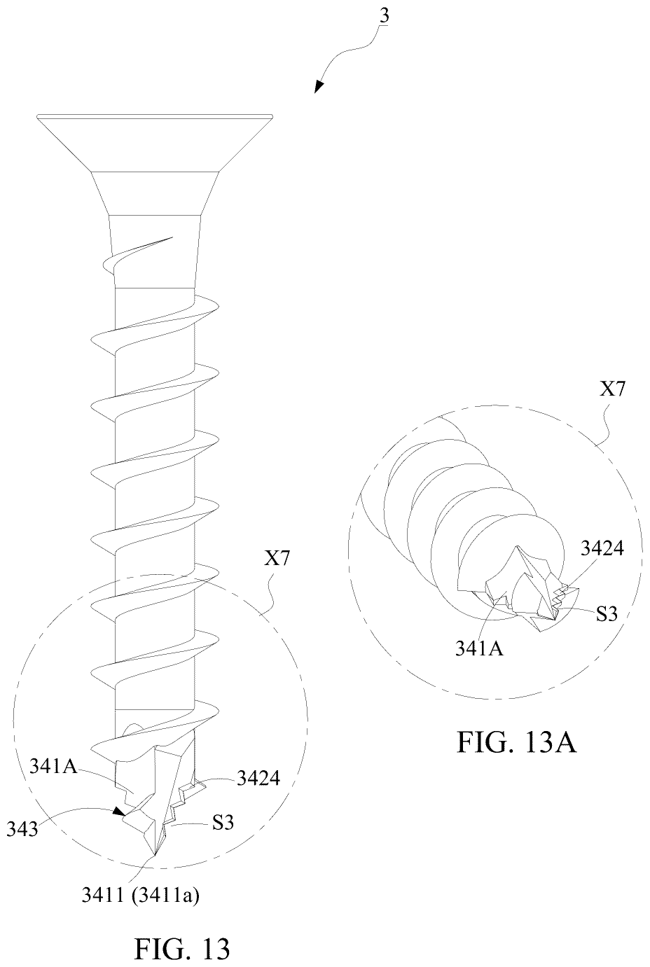

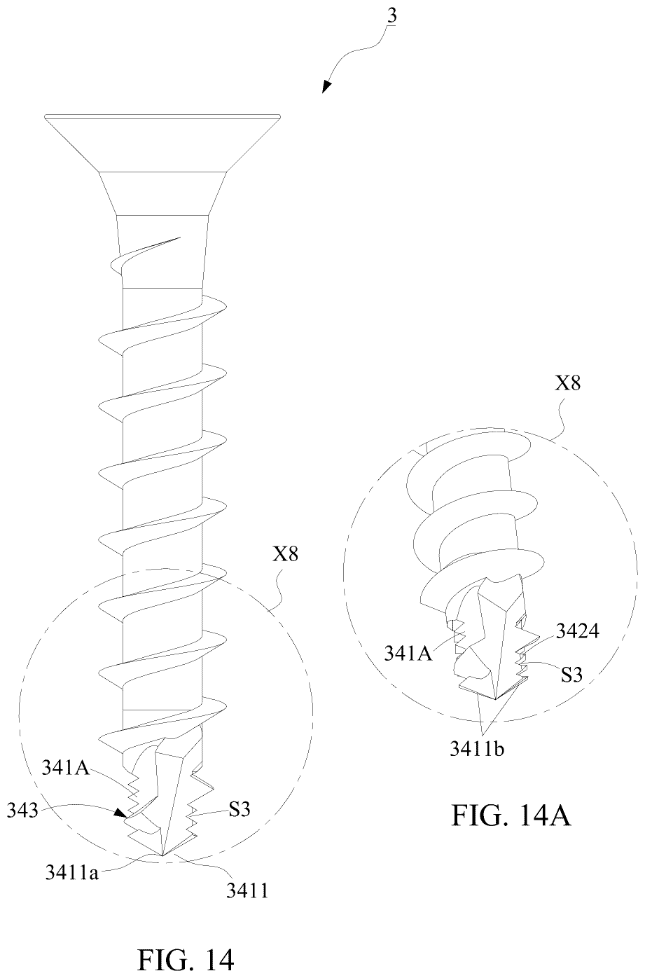

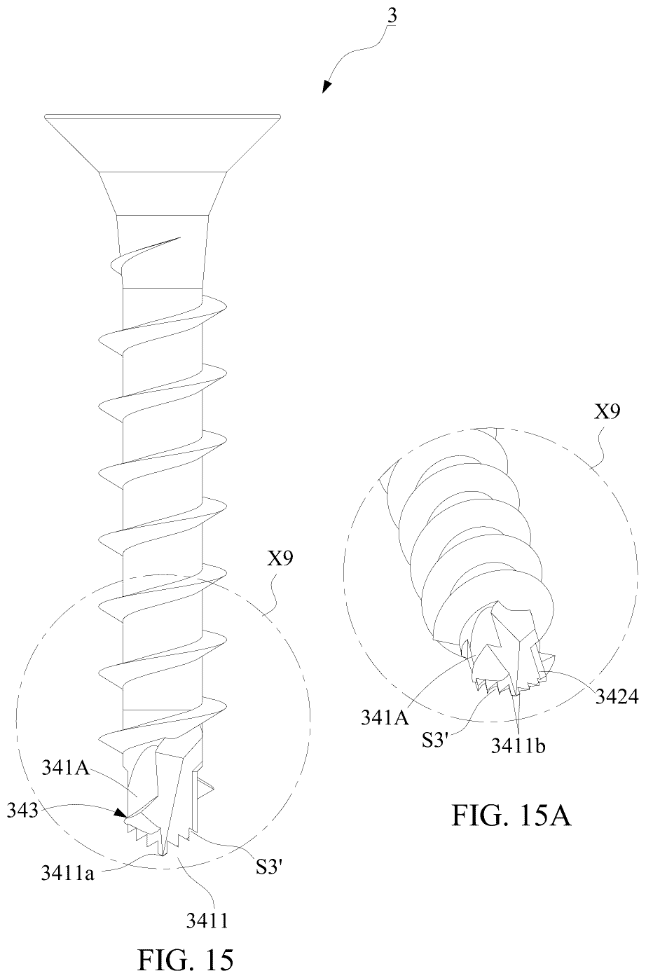

FIG. 13, FIG. 14, and FIG. 15 show a sixth preferred embodiment, a seventh preferred embodiment, and an eighth preferred embodiment of the versatile screw 3 respectively. These embodiments are characterized in that there can be indentations formed on the drill portion 34 to present a toothed arrangement. For example, a plurality of first indentations S3 can combine with the outer periphery of the drilling section 341A of the sharp end structure illustrated by FIG. 2, and the combination is shown in FIG. 13 and FIG. 13A. The first indentations S3 can also combine with the outer periphery of the drilling section 341A of the drill tip structure illustrated by FIG. 12, and the combination is shown in FIG. 14 and FIG. 14A. Alternatively, a plurality of second indentations S3′ can be arranged on the first cones 3411b, and the combination is shown in FIG. 15 and FIG. 15A. Accordingly, this toothed arrangement attains an auxiliary cutting effect to increase the cutting ability of the cutting rib portions 3424 and the drill thread unit 343. Accordingly, the combination of the correlated elements is allowed to remove chips, prevent the workpiece from cracking, reduce the friction between the screw 3 and the workpiece 5 for decreasing the drilling resistance, and increase the drilling efficiency.

Referring to FIG. 16, a ninth preferred embodiment of the versatile screw 3 is shown. Elements of the ninth preferred embodiment are the same as those of the first preferred embodiment. This preferred embodiment is characterized in that the drill body 341 is in the shape of a helix when turned in a direction. That is, the outer periphery of the drilling section 341A is twisted by extending in an arcuate and curved manner in a clockwise direction or in a counterclockwise direction, thereby allowing the accommodation area S1 of each groove region 342 to be in the form of a helical groove. Herein, only the clockwise helical form is shown. This helical arrangement serves to cut the workpiece, accommodate chips, and remove chips, so the drilling ability of the drill portion 34 is increased. Accordingly, the combination of the correlated elements is allowed to decrease the drilling resistance, prevent the cracking problem of the workpiece, and increase the drilling efficiency.

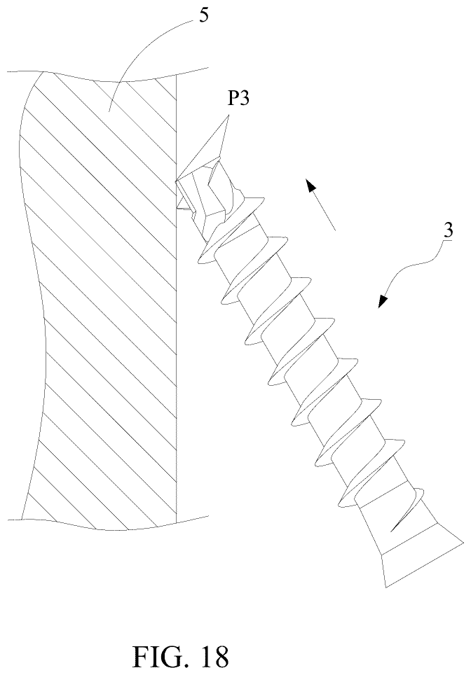

Referring to FIG. 17, a tenth preferred embodiment of the versatile screw 3 is shown. Elements of the tenth preferred embodiment are the same as those of the first preferred embodiment. Different from the first preferred embodiment, the tenth preferred embodiment is characterized in that the end portion 3411 is made without the aforementioned drill tip 3411a. Explicitly, the end portion 3411 is formed with an end surface 3411c, and the end surface 3411c is flat. Preferably, one end of the end surface 3611c can be connected to one of the drilling thread segments 3431. Accordingly, this flat end surface 3411c allows the screw 3 to be inclinedly drilled into a workpiece 5, as shown in FIG. 18. At this moment, two side edges of the end surface 3411c serve as two cutting points P3 available for cutting the workpiece 5 and concurrently cooperate with the cutting rib portions 3424 and the drill thread unit 343 to execute the drilling operation which is conducive to a quick drilling into the workpiece 5. Therefore, the combination of the correlated elements is allowed to remove chips, prevent the cracking problem of the workpiece 5, decrease the drilling resistance, and increase the drilling efficiency.

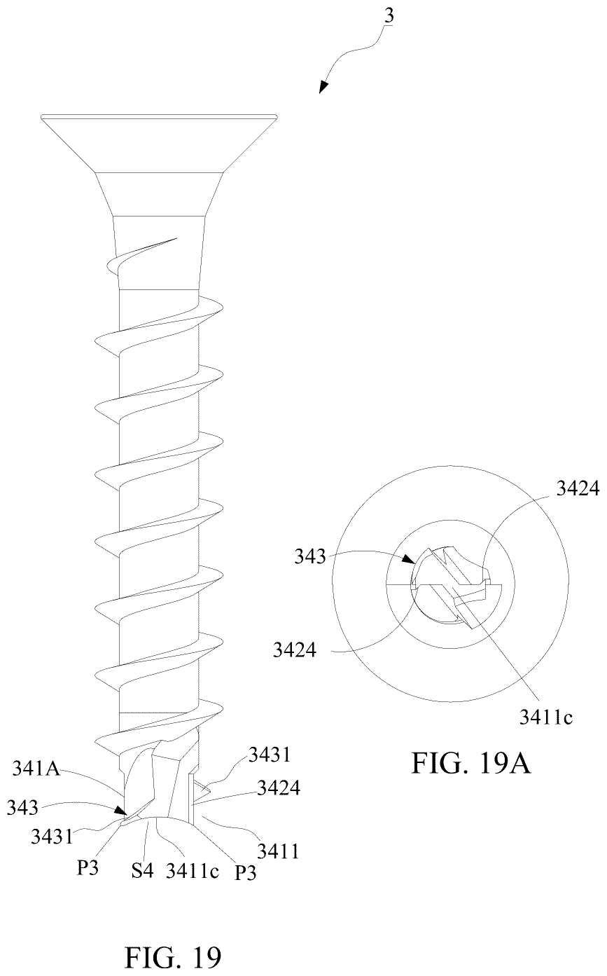

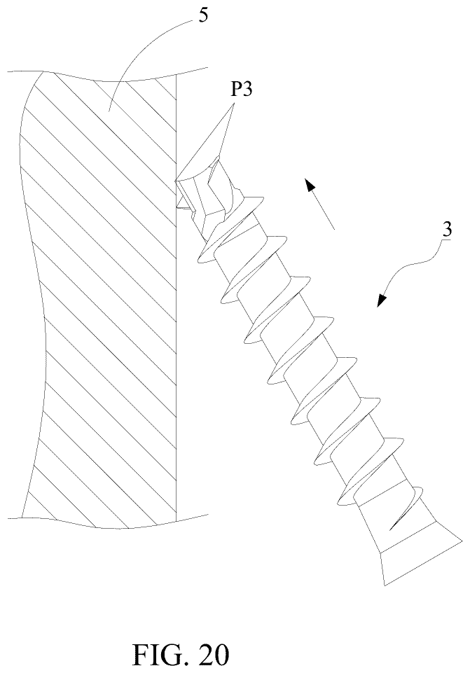

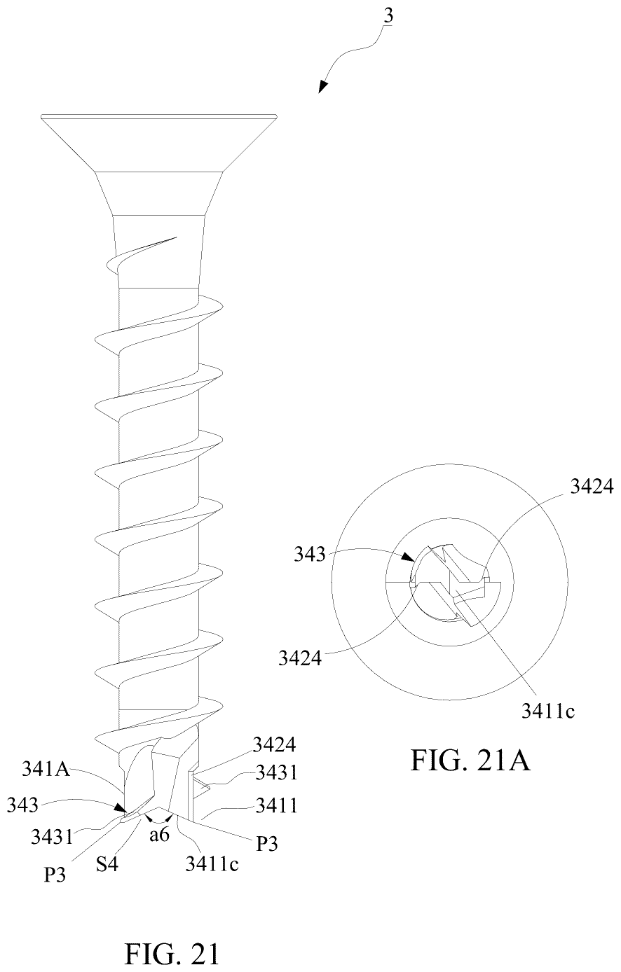

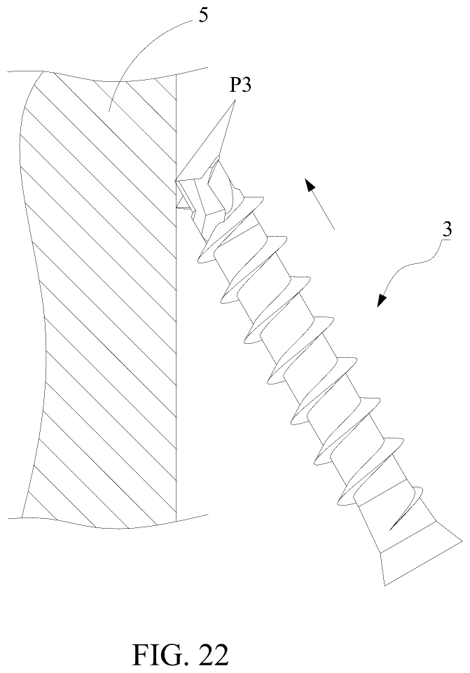

Referring to FIGS. 19 to 22, an eleventh preferred embodiment of the versatile screw 3 is shown. Elements of the eleventh preferred embodiment are the same as those of the tenth preferred embodiment. The eleventh preferred embodiment is characterized in that a recess S4 is recessed inwardly. That is, the recess S4 is recessedly formed into the end surface 3411c. The inward recess can be an arcuate recess S4 (see FIG. 19), a recess S4 having a sixth included angle a6 (see FIG. 21), etc. Referring to FIG. 20 and FIG. 22, the inward recess S4 allows the screw 3 to be inclinedly drilled into a workpiece 5. In this regard, the two side edges serving as the cutting points P3 become sharper, which facilitates a quicker cutting operation. Accordingly, the combination of the correlated elements is allowed to remove chips, prevent the workpiece from cracking, decrease the drilling resistance, and increase the drilling efficiency.

To sum up, this invention is characterized in that a drill portion includes a drilling section on which two groove regions and a drill thread unit can be respectively formed. Each groove region includes an outward-protruding cutting rib portion. Drilling thread segments are each situated on one side of each cutting rib portion. A larger first distance is defined between the cutting rib portions of the opposite groove regions. Accordingly, this invention takes advantage of the cooperation between the cutting rib portions and the drilling thread segments to enlarge a drilled hole and generate pulling force, thereby allowing the drilling section to be quickly drilled into a workpiece, preventing the drill portion from deviating from its right position, and decreasing the drilling resistance. By the combination of the correlated elements, the screw subjects the workpiece to a quicker cutting effect and attains the accommodation and removal of the cut chips so that the workpiece does not crack easily.

While the embodiments are shown and described above, it is understood that further variations and modifications may be made without departing from the scope of this invention.

What is claimed is:

1. A versatile screw comprising a head, a shank extending outwards from said head and defining a central axis, a thread unit disposed on said shank and including a plurality of threads spirally disposed around an outer periphery of said shank, and a drill portion connected to said shank;
wherein said drill portion includes a drill body connected to said shank, two opposite groove regions formed on said drill body, and a drill thread unit winding around said drill body, said drill body extending outwards from said shank and defining a drilling section, said drilling section including an end portion located in opposing relationship to said shank, each of said groove regions including at least one wall connected to said drilling section, an accommodation area enclosed by said at least one wall, and a cutting rib portion protruding outwards from said at least one wall; and
wherein said cutting rib portion defines an end point furthest from said central axis when protruding from said at least one wall, with a first distance defined from said end point of one cutting rib portion of one groove region to another end point of another cutting rib portion of another groove region when viewed from said end portion, a second distance being defined from a junction where said at least one wall of said one groove region and an outer periphery of said drilling section converge to another junction where another at least one wall of said other groove region and said outer periphery of said drilling section converge when viewed from said end portion, said first distance being greater than said second distance, said drill thread unit being disposed in at least one convolution winding around said outer periphery of said drilling section, with said drill thread unit partially cut by said groove regions so that at least two drilling thread segments protrude from said drilling section, each of said drilling thread segments being situated on one side of each said cutting rib portion.

2. The screw according to claim 1, wherein the value of said first distance is 1.01˜1.5 times the value of said second distance.

3. The screw according to claim 1, wherein said outer periphery of said drilling section defines a drill diameter, said outer periphery of said shank defining an outer diameter, the value of said drill diameter being 1.01˜1.4 times the value of said outer diameter.

4. The screw according to claim 1, wherein said outer periphery of said drilling section defines a drill diameter, said outer periphery of said shank defining an outer diameter, the value of said outer diameter being 1.01˜1.4 times the value of said drill diameter.

5. The screw according to claim 1, wherein said end portion is formed with a single drill tip, said drill tip having a third included angle ranging from 40 to 120 degrees.

6. The screw according to claim 1, wherein said end portion includes two first cones each inclined to said central axis, said two first cones converging at a single drill tip, said drill tip having a third included angle ranging from 40 to 120 degrees.

7. The screw according to claim 6, wherein each of said groove regions includes a second cone located on said drilling section and spaced from said end portion, said second cone being inclined to said central axis and extending outwards from said outer periphery of said drilling section.

8. The screw according to claim 1, wherein said end portion is formed with an end surface.

9. The screw according to claim 8, wherein a recess is recessed into said end surface.

10. The screw according to claim 8, wherein one end of said end surface is connected to one of said drilling thread segments.

11. The screw according to claim 1, wherein a plurality of notches are arranged on at least one of said threads.

12. The screw according to claim 1, wherein a plurality of first indentations are arranged on said outer periphery of said drilling section.

13. The screw according to claim 6, wherein a plurality of second indentations are arranged on said first cones.

14. The screw according to claim 1, wherein said drill body is in the shape of a helix when twisted in a direction.

15. The screw according to claim 1, wherein each of said groove regions includes a first wall connected to said outer periphery of said drilling section and extended towards said end portion, a second wall joined to said first wall and located between said first wall and said shank, and a third wall joined to said first wall and said second wall, with said accommodation area enclosed by said first wall, said second wall, and said third wall, with said cutting rib portion formed on said third wall by protruding outwards therefrom.

16. The screw according to claim 15, wherein a joint where said first wall, said second wall, and said third wall are joined has an arcuate surface.

17. The screw according to claim 15, wherein respective wall surfaces of said first wall, said second wall, and said third wall are flat.

18. The screw according to claim 15, wherein respective wall surfaces of said first wall, said second wall, and said third wall are curved.

19. The screw according to claim 1, wherein said at least one wall has a spherical-curved surface.

20. The screw according to claim 1, wherein each of said threads includes an upper thread surface facing said head and a lower thread surface opposite to said upper thread surface, said upper thread surface and said lower thread surface converging at an apex, said apex defining a baseline perpendicular to said central axis, each of said drilling thread segments including an upper flank surface facing said head and a lower flank surface opposite to said upper flank surface, said upper flank surface and said lower flank surface converging at a crest, said crest defining a reference line perpendicular to said central axis, the sum of a first included angle defined between said upper thread surface and said baseline and a second included angle defined between said lower thread surface and said baseline being not greater than the sum of a fourth included angle defined between said upper flank surface and said reference line and a fifth included angle defined between said lower flank surface and said reference line.

21. The screw according to claim 1, wherein each of said threads includes an upper thread surface facing said head and a lower thread surface opposite to said upper thread surface, said upper thread surface and said lower thread surface converging at an apex, said apex defining a baseline perpendicular to said central axis, a first included angle defined between said upper thread surface and said baseline being different from a second included angle defined between said lower thread surface and said baseline.

22. The screw according to claim 1, wherein each of said threads includes an upper thread surface facing said head and a lower thread surface opposite to said upper thread surface, said upper thread surface and said lower thread surface converging at an apex, said apex defining a baseline perpendicular to said central axis, a first included angle defined between said upper thread surface and said baseline being equal to a second included angle defined between said lower thread surface and said baseline.

23. The screw according to claim 1, wherein each of said drilling thread segments including an upper flank surface facing said head and a lower flank surface opposite to said upper flank surface, said upper flank surface and said lower flank surface converging at a crest, said crest defining a reference line perpendicular to said central axis, a fourth included angle defined between said upper flank surface and said reference line being equal to a fifth included angle defined between said lower flank surface and said reference line.

24. The screw according to claim 1, wherein each of said drilling thread segments including an upper flank surface facing said head and a lower flank surface opposite to said upper flank surface, said upper flank surface and said lower flank surface converging at a crest, said crest defining a reference line perpendicular to said central axis, a fourth included angle defined between said upper flank surface and said reference line being different from a fifth included angle defined between said lower flank surface and said reference line.

25. The screw according to claim 1, wherein each of said threads is in the form of a non-circular shape.

26. The screw according to claim 1, wherein said shank is in the form of a non-circular shape.

27. The screw according to claim 1, wherein each of said groove regions is formed on said drilling section and extends in the direction of said head so that each said groove region is extended in length.

28. The screw according to claim 1, wherein said drill thread unit is disposed in more than one convolution winding arrangement so that the distribution of said drilling thread segments is enlarged.
